(19) United States
(12) Patent Application Publication
(10) Pub. No.: US 2025/0014140 A1
(43) Pub. Date: Jan. 9, 2025

(54) PHYSICAL SUBSAMPLED RGB FORMAT SUBPIXEL TILE RENDER SYSTEM AND METHOD

(71) Applicant: QUALCOMM Incorporated, San Diego, CA (US)

(72) Inventors: Nan Zhang, Beijing (CN); Bo Du, Xi'an (CN); Yongjun Xu, Beijing (CN)

(21) Appl. No.: 18/712,617

(22) PCT Filed: Dec. 17, 2021
(86) PCT No.: PCT/CN2021/139209

§ 371 Date: May 22, 2024

(51) Int. Cl. G06T 1/20; G06T 11/00

(52) U.S. Cl. CPC G06T 1/20; G06T 11/001; G06T 2200/12; G06T 2200/28

(57) ABSTRACT

A video processing system includes a graphics subsystem including a graphics processing unit (GPU) and a frame buffer. The GPU is configured to obtain a physical pixel layout corresponding to a display architecture of an electronic display, wherein the physical pixel layout is characterized by a non-uniform subpixel arrangement; receive image data, including a matrix of logical pixel chroma values; subsample the matrix of logical pixel chroma values according to the physical pixel layout to produce subsampled image data having a subpixel rendered format corresponding to the non-uniform subpixel arrangement; store the subsampled image data in the frame buffer; and enable transfer of the subsampled image data to a display processing unit (DPU) of the electronic display for composition of frames having the non-uniform subpixel arrangement.

### TECHNICAL FIELD

This disclosure relates to graphics rendering system, and specifically to a graphics processing unit that processes image data using physical subpixel arrangements of a display panel.

### BACKGROUND

Graphics rendering techniques process image data using logical pixel arrangements. Such arrangements typically include red, green, and blue (RGB) pixels having the same size, shape, and layout density. Graphics processing units (GPUs) perform binning and rendering passes based on such logical pixel arrangements, compose video frames, and store the video frames in a frame buffer. A display processing unit (DPU) specific to a particular display obtains the video frames and performs further processing to convert the pixels in the video frames to physical pixel arrangements corresponding to the physical pixel layout of the display. The DPU displays the video frames on the display according to the physical pixel arrangements.

The conversion between logical physical arrangements and physical pixel arrangements is often inefficient in terms of storage size and processing performance. The frame buffer must be large enough to store all of the logical pixels, and the GPU and DPU must be efficient enough to process all of the logical pixels, regardless of logical to physical pixel correspondences or lack thereof. As physical pixel arrangements continue to become more diverse compared to convention logical pixel arrangements, such inefficiencies continue to increase, thereby decreasing performance in graphics rendering systems.

### SUMMARY

Graphics rendering techniques according to the present disclosure process image data using pixel arrangements that correspond to physical pixel layouts of the display panels on which the image data is meant to be displayed. Such techniques therefore optimize the logical-to-physical pixel layout conversion process, decrease frame buffer storage requirements, and increase performance in graphics rendering systems.

In one aspect, a video processing system includes a graphics subsystem including a graphics processing unit (GPU) and a frame buffer. The GPU is configured to obtain a physical pixel layout corresponding to a display architecture of an electronic display, wherein the physical pixel layout is characterized by a non-uniform subpixel arrangement; receive image data, including a matrix of logical pixel chroma values; subsample the matrix of logical pixel chroma values according to the physical pixel layout to produce subsampled image data having a subpixel rendered format corresponding to the non-uniform subpixel arrangement; store the subsampled image data in the frame buffer; and enable transfer of the subsampled image data to a display processing unit (DPU) of the electronic display for composition of frames having the non-uniform subpixel arrangement.

In some implementations, the GPU is further configured to perform pixel binning on the subsampled image data having the subpixel rendered format; perform the pixel binning using rectangle tiles enlarged by N logical pixels, where N is an integer greater than or equal to 1 and is selected to cover overlaps between physical subpixels of the physical pixel layout and logical subpixels of the received image data; perform texture processing on the subsampled image data having the subpixel rendered format; and/or perform antialiasing on the subsampled image data having the subpixel rendered format.

Therefore, the GPU is configured to render only subpixels of the subsampled image data that correspond to physical subpixels disposed on the electronic display, and store in the frame buffer only subpixels of the subsampled image data that correspond to physical subpixels disposed on the electronic display.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 is a block diagram of a video processing system in accordance with some implementations.

FIG. 2 is a block diagram of a GPU rendering process flow in accordance with some implementations.

FIG. 3 includes diagrams depicting rendering techniques and subpixel arrangement types in accordance with some implementations.

FIG. 4 is a diagram depicting logical pixel and physical pixel arrangements in accordance with some implementations.

FIG. 5 is a diagram depicting a GPU rendering process flow in accordance with some implementations.

FIG. 6 is a flow diagram depicting a bin/tile subpixel rendering method in accordance with some implementations.

### DETAILED DESCRIPTION

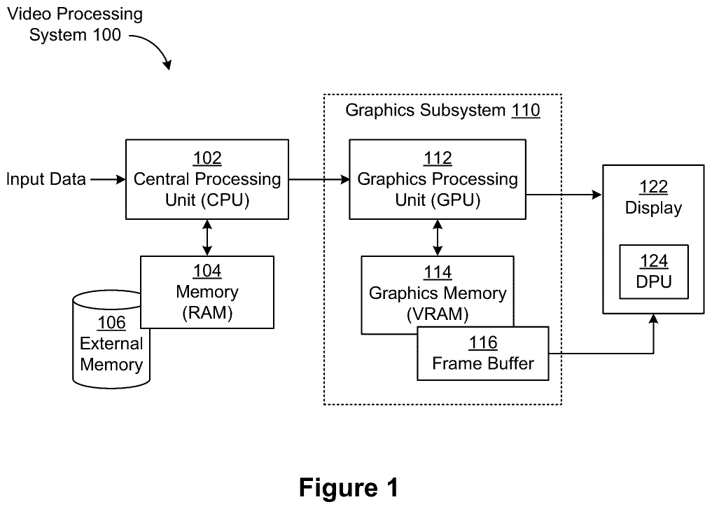

FIG. 1 is a block diagram of a video processing system 100 in accordance with some implementations. The video processing system 100 includes a central processing unit (CPU) 100, memory (such as random access memory (RAM)) 104, external memory 106, a graphics subsystem 110 including a graphics processing unit (GPU) 112, graphics memory (such as video random access memory (VRAM)) 114, and a frame buffer 116, and a display 122 including a display processing unit (DPU) 124.

The CPU 102 (also referred to as a processor or a main processor) receives input data, which is image data intended for display on the display 122 in the form of video frames. The input data may also be referred to as an input signal. The CPU 102 includes one or more processors or any other electronic circuitry configured to execute instructions comprising a computer program (e.g., programs stored in the memory 104). The CPU 102 performs initial processing on the input data and provides the input data to the graphics subsystem 110 for rendering.

The memory 104 and 106 includes a non-transitory computer readable storage medium, such as volatile memory (e.g., one or more random access memory devices) and/or non-volatile memory (e.g., one or more flash memory devices, magnetic disk storage devices, optical disk storage devices, or other non-volatile solid state storage devices). The memory may include one or more storage devices remotely located from the processor(s). The memory stores programs (described herein as modules and corresponding to sets of instructions) that, when executed by the processor(s), cause the video processing system 100 to perform functions as described herein. The modules and data described herein need not be implemented as separate programs, procedures, modules, or data structures. Thus, various subsets of these modules and data may be combined or otherwise rearranged in various implementations.

The GPU 112 (also referred to as a graphics processor or a graphics card) includes one or more processors or any other electronic circuitry configured to execute instructions comprising a computer program (e.g., programs stored in the memory 104, 106, and/or 114). The GPU 112 is a specialized processor configured to accelerate graphics rendering. The GPU 112 is configured to process many pieces of image data simultaneously, compose image frames, and convey the image frames to the display 122 via the frame buffer 116.

The graphics memory 114 stores the image data while it is being processed by the GPU 112, and the frame buffer 116 stores the image data in the form of video frames upon the completion of processing by the GPU 112. The graphics memory 114 and frame buffer 116 each include a non-transitory computer readable storage medium, such as volatile memory (e.g., one or more random access memory devices) and/or non-volatile memory (e.g., one or more flash memory devices, magnetic disk storage devices, optical disk storage devices, or other non-volatile solid state storage devices). The graphics memory 114 and frame buffer 116 may each include one or more storage devices remotely located from the GPU 112, or integrated with the GPU 112. The graphics memory 110 is dedicated to producing images in the form of frames (graphical representations) for display on a display panel 122. The graphics memory 110 may be referred to as GDDR or DDR/G-MEM (double data rate (DDR) memory specialized for fast rendering on GPUs). The GPU 112 conveys frames (also referred to as frame buffers) from the frame buffer 116 to the display 122.

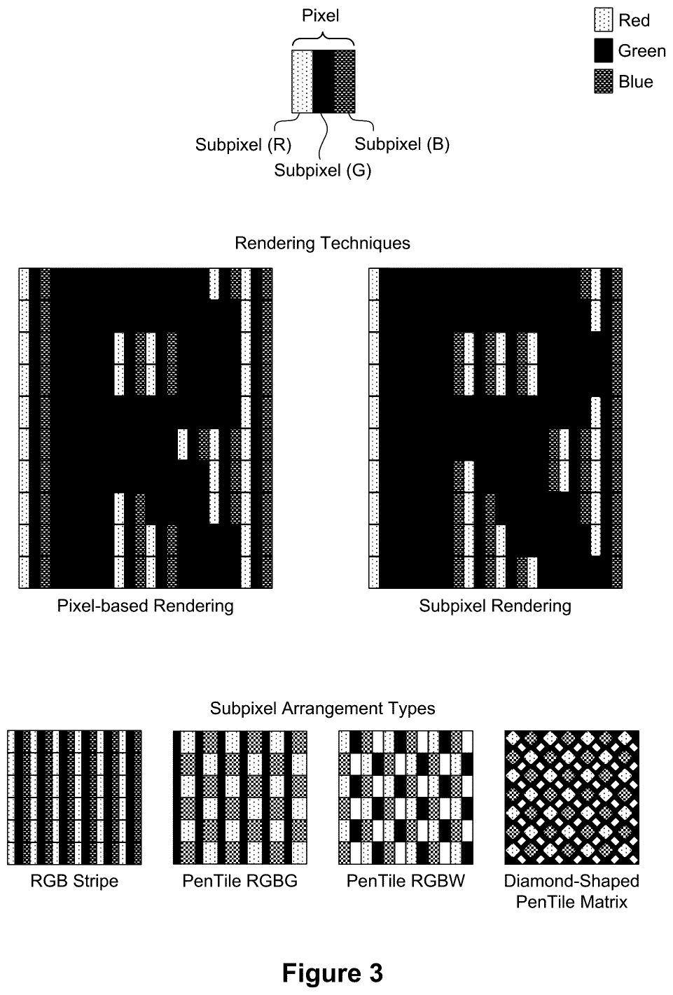

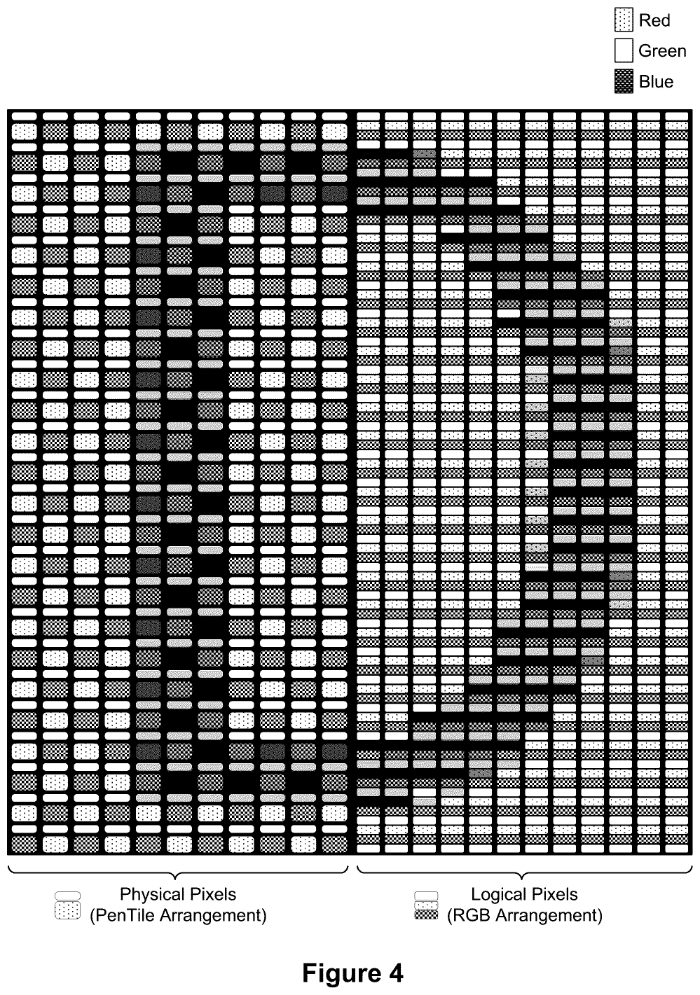

The display 122 is an electronic display including a matrix of physical pixels arranged in a particular pattern. Physical pixel arrangements are described in more detail below with reference to FIGS. 3 and 4. Display 122 may be a liquid crystal display (LCD) display, light-emitting diode (LED) display, organic light-emitting diode (OLED) display, quantum dot light-emitting diode (QLED) display, active-matrix organic light-emitting diodes (AMOLED) display, in-plane switching (IPS) display, thin-film transistor (TFT) display, plane to live switching (PLS) display, low temperature polysilicon (LTPS) display, low-temperature polycrystalline oxide (LTPO) display, or any other type of electronic display having a physical pixel arrangement.

The DPU 124 (also referred to as a display processor) includes one or more processors that are configured to transform display processor code corresponding to the image frames conveyed from the frame buffer 116 into graphical representations (images). The DPU 124 may include one or more of a display controller, display file memory, a display generator, and a display console. The DPU 124 converts digital information corresponding to the image frames to analog data corresponding to pixel voltages. This digital-to-analog conversion depends on the physical characteristics and graphics functions of the display 122.

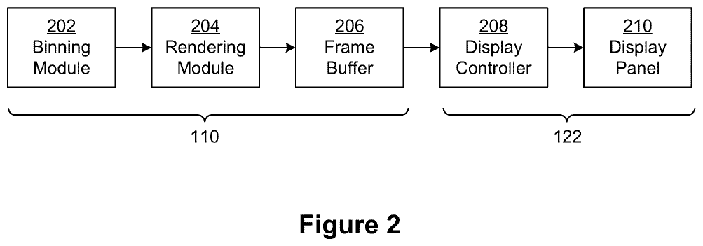

FIG. 2 is a block diagram of a GPU rendering process flow in accordance with some implementations. In some implementations, the graphics subsystem 110 (specifically, the GPU 112) performs tile-based render architecture passes, including a binning pass and a rendering pass, on the image data. In GPUs that have memory bandwidth limitations (e.g., GPUs in mobile devices), binning splits work into small pieces to decrease overall memory bandwidth consumption. As such, tile-based rendering achieves efficient utilization of all available resources and gains acceptable performance.

The binning module 202 is configured to perform the binning pass, which includes generating streams/maps between frame tiles and corresponding geometry that should be rendered into particular tiles. In conventional processes, the binning pass may be performed on logical pixels having a predetermined arrangement having little to no relation to the physical pixel arrangement corresponding to the display 122 on which the image data is to be displayed. The techniques described in this disclosure, however, perform the binning pass on pixels having an arrangement corresponding to a specific physical pixel layout for a particular display 122 on which the image data is intended to be displayed. The binned image data is passed to the rendering module 204 for rendering.

The rendering module 204 is configured to perform the rendering pass, which includes taking the maps between tiles and geometry and rendering the appropriate pixels per tile. In conventional processes, the rendering pass may be performed on logical pixels having a predetermined arrangement having little to no relation to the physical pixel arrangement corresponding to the display 122 on which the image data is to be displayed. The techniques described in this disclosure, however, perform the rendering pass on pixels having an arrangement corresponding to a specific physical pixel layout for a particular display 122 on which the image data is intended to be displayed. The rendered image data is passed to the frame buffer 206.

The frame buffer 206 temporarily stores image frames to be conveyed to the display 122. The frame buffer corresponds to the frame buffer 116 in FIG. 1 described above. The GPU 112 enables transfer of the image data to the display controller 208 of the display 122.

The display controller 208 corresponds to the DPU 124 I FIG. 1 described above. The display controller 208 converts the image data to analog signals that operate the physical pixels of the display panel 210 of the display 122.

The display panel 210 includes a matrix (also referred to as an array or an arrangement) of physical pixels that, when operated at varying degrees of luminance (brightness) and chrominance (color), cause images (graphical representations of the image data) to be displayed on the display 122.

FIG. 3 includes diagrams depicting rendering techniques and subpixel arrangement types in accordance with some implementations. Each pixel includes at least two subpixels, each subpixel corresponding to a different color.

In pixel-based rendering, a pixel is the smallest addressable element in an all points addressable display device. Thus, it is the smallest controllable element of a picture represented on the display. Each pixel is accessible to the DPU, and its brightness is controlled at the pixel level. Specifically, the pixel may be turned on at a specific brightness (luminance) or turned off. The subpixels within the pixel are not individually accessible to the DPU.

In subpixel rendering, each subpixel is an addressable element and is the smallest controllable element of a picture represented on the display. Each subpixel is accessible to the DPU. Thus, the DPU may control the brightness of each individual subpixel. Specifically, each subpixel may be turned on at a specific brightness (luminance) or turned off, regardless of the state of other subpixels of a given pixel. Subpixel rendering provides for higher quality images with greater image texture. Image texture is a set of metrics calculated in image processing designed to quantify the perceived texture of an image. Image texture is associated with the spatial arrangement of color or intensities in an image or selected region of an image. With elements of the image being controllable at the subpixel level, the various lines and shapes that make up the image look smoother and less disjointed.

Pixels and subpixels are arranged in a particular arrangement (also referred to as pixel layout, pattern, or matrix). Pixels may be laid out in RGB stripes, including columns or rows of repeating squares or rectangles of subpixels in alternating patterns. Such an arrangement may be referred to as a uniform subpixel arrangement.

Pixels and their corresponding subpixels may be arranged in non-uniform arrangements. In some implementations, each pixel in a non-uniform arrangement may include a first subpixel (e.g., green) having a first size and a second subpixel (e.g., red or blue) having a second size larger than the first size (as depicted in the PenTile RGBG and diamond-shaped PenTile matrix arrangements). In some implementations, each pixel in a non-uniform arrangement may include one subpixel having a first color (e.g., red or blue) and two subpixels having a second color different from the first color (e.g., green). In some implementations, each pixel in a non-uniform arrangement may include less than three subpixels (as depicted in the Pentile RGBG and diamond-shaped PenTile matrix arrangements) or more than three subpixels (as depicted in the PenTile RGBW arrangement). Non-uniform arrangements may include any other arrangement of pixels and subpixels in which the color patterns do not uniformly repeat in each column (as depicted in the RGB stripe arrangement in FIG. 3) and/or in each row (as depicted in the RGB stripe arrangement in FIG. 4).

FIG. 4 is a diagram depicting logical pixel and physical pixel arrangements in accordance with some implementations. For purposes of discussion and for extra clarity in comparing logical and physical pixel arrangements, only half of the image in FIG. 4 is portrayed in each format.

As discussed above with reference to FIG. 2, the graphics subsystem 110 operates on logical pixels while the display 122 includes arrangements of physical pixels. If the logical pixels and the physical pixels have different layouts, as depicted in FIG. 4, then the graphics subsystem 110 may waste both processing bandwidth and storage resources on logical pixels that have no corresponding physical pixel on the display 122.

As shown in FIG. 4, an image composed of logical pixels having an RGB strip arrangement may include more pixels than an image composed of physical pixels having a PenTile RGBG arrangement. A conventional graphics subsystem would process the extra pixels (costing processing bandwidth) and store the extra pixels in the frame buffer (costing storage resources), even though the extra pixels are redundant and do not add anything to the final depiction of the image on the physical display panel. When conveyed to the display, the DPU converts the image to a format corresponding to the physical pixel layout, thereby discarding data describing redundant logical pixels that have no corresponding physical pixels.

To minimize unnecessary processing bandwidth and storage overhead, the graphics processing techniques disclosed in this application operate on logical pixels that are arranged according to the particular non-uniform arrangement of the display architecture of the particular display 122 on which the image is to be displayed. Thus, referring to the example in FIG. 4, if the physical pixels of a given display are arranged in a PenTile RGBG arrangement, then the graphics subsystem 110 processes the image data according to the PenTile RGBG layout (and not according to the RGB strip layout as depicted in the figure). Thus, substantially all of the image data processed at the graphics subsystem 110 corresponds to physical pixels included in the display 122.

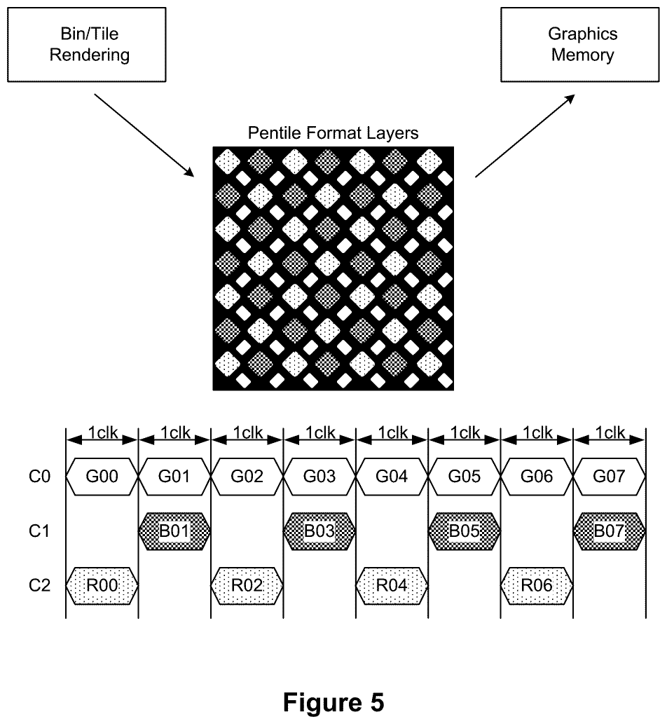

FIG. 5 is a diagram depicting a GPU rendering process flow in accordance with some implementations. During the binning pass, streams of image data (sometimes referred to as visibility streams) are generated based on a non-uniform subpixel layout. Tile rectangle binning may be enlarged an additional N logical pixels (e.g., 1-2 logical pixels) to cover physical subpixel layout overlaps.

In some implementations, the GPU 112 performs anti-aliasing based on the physical subpixel layout and formats the image data using pre-obtained knowledge of the display subpixel physical layout. Up-sampled pixel RGB values may be used to produce physical sub pixel values directly. The anti-aliasing parameters may be aligned or tuned on the physical display. Thus, texture can be provided directly in subpixel rendering format.

During the rendering pass, layers may be conveyed to graphics memory and finally resolved to system memory. The layers may be conveyed in (i) non-uniform physical subpixel format (e.g., PenTile and others), or (ii) sub-sampled RGB intermediate format (e.g., GRB 4:2:2, GRB 4:2:0, or others) and then the DPU may filter and/or calibrate the conveyed layers to the final physical subpixel values.

In the example of a diamond-shaped PenTile subpixel layout, as depicted in FIG. 5, data associated with each subpixel may be processed and conveyed during the rendering pass in accordance with a timing diagram associated with the physical pixel layout. For example, groups of two subpixels may be processed and conveyed each successive clock cycles. Specifically, referring to FIG. 5, a green pixel G00 and a red subpixel R00 may be processed during a first clock cycle, a green subpixel G01 and a blue subpixel B01 may be processed during a second clock cycle, and so forth.

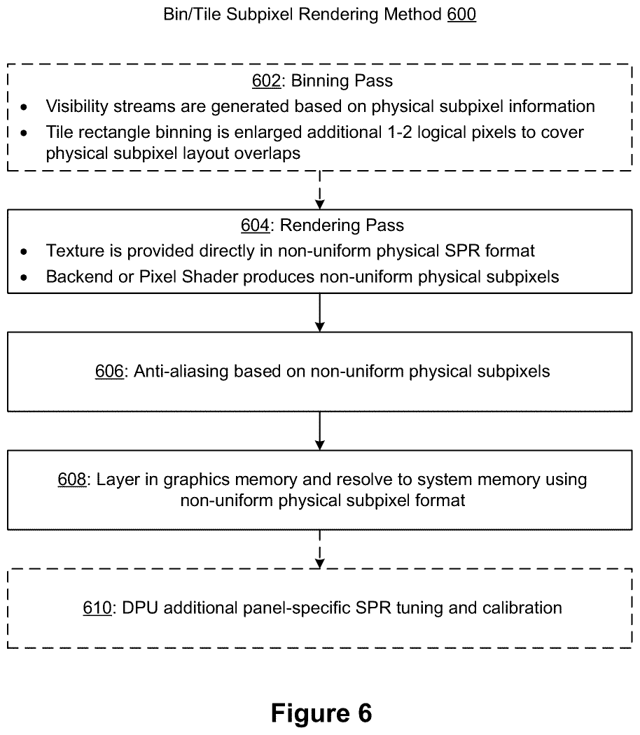

FIG. 6 is a flow diagram depicting a bin/tile subpixel rendering method in accordance with some implementations. The method may be governed by instructions that are stored in a computer memory or non-transitory computer readable storage medium. The instructions may be included in one or more programs stored in the non-transitory computer readable storage medium. When executed by one or more processors (e.g., 102, 112, and/or 124), the instructions cause a video processing system (e.g., 100) to perform the process. The non-transitory computer readable storage medium may include one or more solid state storage devices (e.g., Flash memory), magnetic or optical disk storage devices, or other non-volatile memory devices. The instructions may include source code, assembly language code, object code, or any other instruction format that can be interpreted by one or more processors. Some operations in the process may be combined, and the order of some operations may be changed.

A binning module 202 of a GPU 112 of a graphics subsystem 110 of the video processing system performs (602) a binning pass, generating visibility streams based on physical subpixel information associated with a display panel 210 of the video processing system. The physical subpixel information includes a physical pixel layout corresponding to a display architecture of the display, and the physical pixel layout is characterized by a non-uniform subpixel arrangement.

In some implementations, the binning module 202 obtains the physical subpixel information (including the pixel layout corresponding to the display architecture of the display) as part of the method 600. In other implementations, the physical subpixel information (including the pixel layout corresponding to the display architecture of the display) is stored locally at the graphics subsystem 110 prior to the method 600 being executed. In such implementations, the binning module 202 has access to the physical subpixel information when method 600 begins.

In performing the binning pass, the binning module 202 receives image data, including a matrix of logical pixel chroma values, and subsamples the matrix of logical pixel chroma values according to the physical pixel layout to produce subsampled image data having a subpixel rendered format corresponding to the non-uniform subpixel arrangement. Stated another way, the binning pass performs subpixel binning based on the non-uniform subpixel arrangement of the physical pixel layout of the display.

In some implementations, the binning module 202 performs the pixel binning using rectangle tiles enlarged by N logical pixels, where N is an integer greater than or equal to 1 and is selected to cover overlaps between (i) physical subpixels of the physical pixel layout and (ii) logical subpixels of the received image data. In other words, for scenarios in which logical subpixels and physical subpixels do not map to each other on a one-to-one basis, the binning module 202 may extend the rectangle tiles by a small number (e.g., 1 or 2) of logical pixels in order to ensure that all physical pixels corresponding to the logical pixels in a given tile are covered in the binning pass for that tile.

A rendering module 204 of the GPU 112 of the graphics subsystem 110 of the video processing system performs (604) a rendering pass on the binned/tiled image data. In some implementations, the rendering pass includes texture processing (providing texture) directly in the subpixel rendered format (on the subsampled image data having the subpixel rendered format). As discussed above, the rendering module 204 renders only subpixels of the subsampled image data that correspond to physical subpixels disposed on the electronic display. Stated another way, the logical subpixels used as the basis for the rendering pass are configured in the same arrangement as the physical subpixels of the display panel.

The rendering module 204 of the GPU 112 performs (606) antialiasing on the subsampled image data having the subpixel rendered format (on the non-uniform physical subpixels). Performing antialiasing on pixels having the non-uniform physical subpixel arrangement provides for smoother edges, which increases the quality of the rendered images.

The render module 204 stores the rendered subsampled image data in the frame buffer 206. In some implementations, the GPU is configured to store in the frame buffer only subpixels of the subsampled image data that correspond to physical subpixels disposed on the electronic display. In doing so, the GPU layers the rendered image data in graphics memory and resolves the rendered image data to system memory using the non-uniform physical subpixel format of the display panel. Stated another way, after the rendering pass, when performing composition, the GPU puts layers together to generate display frames that are already configured for the display panel before being conveyed to the DPU. Thus, RGB layers are sub-sampled to subpixel rendering format, composition is performed on the physical subpixels, and the composed frames are conveyed to the frame buffer in sub-sampled subpixel rendered format.

In some implementations, the rendered subsampled image data directly corresponds to the physical subpixels in the electronic display. In other implementations, the rendered subsampled image data may not directly correspond to the physical pixels, but at least proportionally corresponds to the physical pixels, thereby still providing the DPU with data that can be converted to physical pixel data with relative computational simplicity. Specifically, while a conventional rendering process may store logical pixels that are not dependent on the physical display pixel/subpixel format of the electronic display (e.g., logical pixels having an RGB fully-sampled pixel format or YUV422 or YUV420-related pixel format), the rendering pass as described herein stores logical pixels in the frame buffer that are directly equal or otherwise proportionally linked to the physical display pixel/subpixel format of the electronic display.

For example, logical pixels stored in the frame buffer (FB) may directly correspond to physical pixels of the electronic display. The logical pixels in the frame buffer may be referred to as having a direct physical subpixel format. Every byte in the frame buffer is equal to a corresponding subpixel value of the physical display. For example, if the electronic display includes physical pixels arranged in an RGGB format (each color for a pixel being represented by 8 bits, 10 bits, or 12 bits, for example), the following examples illustrate logical pixel formats that may be stored in the frame buffer (as a result of the rendering pass) and passed to the DPU:
R 08 bits|G 08 bits|G 08 bits|B 08 bits
R 10 bits|G 10 bits|G 10 bits|B 10 bits
R 12 bits|G 12 bits|G 12 bits|B 12 bits
or any other physical pixel display format known now or in the future.

As another example, logical pixels stored in the frame buffer (FB) may proportionally correspond to physical pixels of the electronic display. The logical pixels in the frame buffer may be referred to as having an intermediate physical subpixel format, but every byte in the frame buffer has a simple conversion formula. For example, if the electronic display includes physical pixels arranged in an RGGB format (each color for a pixel being represented by 8 bits), for example), the following examples illustrate logical pixel formats that may be stored in the frame buffer (as a result of the rendering pass) and passed to the DPU:
R 16 bits|G 16 bits|G 16 bits|B 16 bits
R 16 bits|G 08 bits|G 08 bits|B 08 bits

In general, for an intermediate physical subpixel formats, the final physical subpixel value (at the DPU)=the subpixel value (in the frame buffer)*a ratio. To illustrate, in one example:

R (at DPU)=R (in FB)*0.6

B (at DPU)=B (in FB)*0.6

G (at DPU)=G (in FB)*1

The GPU enables transfer of the subsampled image data to a DPU (208) of the display 122 for composition of frames having the non-uniform subpixel arrangement. Specifically, the frames transferred to the DPU only include data for pixels corresponding to physical pixels included in the display panel of the display. Thus, the DPU does not need to convert logical pixels to physical pixels (or if it does, the processing is minimized due to the correspondence of each logical pixel to a physical pixel included in the display panel). For implementations in which logical pixels proportionally correspond to physical pixels, the DPU performs relatively simple conversions of logical pixels to physical pixels (e.g., multiplying each logical pixel value of a particular color by a predetermined ratio for that color).

In some implementations, the DPU performs (610) additional display panel-specific subpixel rendering tuning and calibration. However, this additional processing is greatly streamlined due to the pixel data associated with the frames conveyed from the frame buffer already directly or proportionally corresponding to the physical pixel layout of the display.

By performing the method 600 as described above, the following scenarios may be achieved. One single layer may cover the full frame, as there is no need to compose frames with conventional RGB layers. Further, direct physical subpixel rendering saves memory usage, which benefits memory (e.g., RAM) size sensitive devices. Further, direct physical subpixel rendering saves graphics memory size, which benefits graphics memory size-sensitive chipsets and devices. Additionally, direct subpixel rendering provides relatively simple render contexts, which benefits power-sensitive and performance-sensitive devices. Moreover, future display techniques may use physical subpixel formats that are even more different from current RGB/YUV formats. In such scenarios, direct physical subpixel rendering allows for seamless processing of future pixel arrangements at the GPU, regardless of how much more complicated the physical pixel layouts may be. In addition, by performing anti-aliasing based on physical pixel arrangements, subpixel-level anti-aliasing may be optimized for the way images will actually be viewed at the physical display panel, thereby increasing image quality.

Thus, by taking the physical space, geometry, and layout of the display panel into account at the rendering stage of graphics processing as disclosed herein, improvements in power, performance, and visual quality and sharpness may be achieved. In addition, future display technologies that use physical subpixels arranged in non-uniform manners may benefit from this this technique. Lastly, by directly using the physical subpixel layout of the display panel, anti-aliasing may be more effective in increasing visual quality and sharpness.

The foregoing description has been described with reference to specific implementations. However, the illustrative discussions above are not intended to be exhaustive or to limit the claims to the precise forms disclosed. Many variations are possible in view of the above teachings. The implementations were chosen and described to best explain principles of operation and practical applications, to thereby enable others skilled in the art.

The various drawings illustrate a number of elements in a particular order. However, elements that are not order dependent may be reordered and other elements may be combined or separated. While some reordering or other groupings are specifically mentioned, others will be obvious to those of ordinary skill in the art, so the ordering and groupings presented herein are not an exhaustive list of alternatives.

As used herein: the singular forms “a”, “an,” and “the” include the plural forms as well, unless the context clearly indicates otherwise; the term “and/or” encompasses all possible combinations of one or more of the associated listed items; the terms “first,” “second,” etc. are only used to distinguish one element from another and do not limit the elements themselves; the term “if” may be construed to mean “when,” “upon,” “in response to,” or “in accordance with,” depending on the context; and the terms “include,” “including,” “comprise,” and “comprising” specify particular features or operations but do not preclude additional features or operations.

1. A video processing system, comprising:
a graphics subsystem including a graphics processing unit (GPU) and a frame buffer;
wherein the GPU is configured to:
obtain a physical pixel layout corresponding to a display architecture of an electronic display, wherein the physical pixel layout is characterized by a non-uniform subpixel arrangement;
receive image data, including a matrix of logical pixel chroma values;
subsample the matrix of logical pixel chroma values according to the physical pixel layout to produce subsampled image data having a subpixel rendered format corresponding to the non-uniform subpixel arrangement;
store the subsampled image data in the frame buffer; and
enable transfer of the subsampled image data to a display processing unit (DPU) of the electronic display for composition of frames having the non-uniform subpixel arrangement.

2. The video processing system of claim 1, wherein the GPU is further configured to perform pixel binning on the subsampled image data having the subpixel rendered format.

3. The video processing system of claim 2, wherein the GPU is configured to perform the pixel binning using rectangle tiles enlarged by N logical pixels, where N is an integer greater than or equal to 1 and is selected to cover overlaps between physical subpixels of the physical pixel layout and logical subpixels of the received image data.

4. The video processing system of claim 1, wherein the GPU is further configured to perform texture processing on the subsampled image data having the subpixel rendered format.

5. The video processing system of claim 1, wherein the GPU is further configured to perform antialiasing on the subsampled image data having the subpixel rendered format.

6. The video processing system of claim 1, wherein the GPU is configured to render only subpixels of the subsampled image data that correspond to physical subpixels disposed on the electronic display.

7. The video processing system of claim 1, wherein the GPU is configured to store in the frame buffer only subpixels of the subsampled image data that correspond to physical subpixels disposed on the electronic display.

8. The video processing system of claim 1, wherein each pixel of the non-uniform subpixel arrangement includes a first subpixel having a first size and a second subpixel having a second size larger than the first size.

9. The video processing system of claim 1, wherein each pixel of the non-uniform subpixel arrangement includes one subpixel having a first color and two subpixels having a second color different from the first color.

10. The video processing system of claim 1, wherein each pixel of the non-uniform subpixel arrangement includes less than three subpixels or more than three subpixels.

11. A method of operating a video processing system, the method comprising:
at a graphics subsystem including a graphics processing unit (GPU) and a frame buffer;
obtaining a physical pixel layout corresponding to a display architecture of an electronic display, wherein the physical pixel layout is characterized by a non-uniform subpixel arrangement;
receiving image data, including a matrix of logical pixel chroma values;
subsampling the matrix of logical pixel chroma values according to the physical pixel layout to produce subsampled image data having a subpixel rendered format corresponding to the non-uniform subpixel arrangement;
storing the subsampled image data in the frame buffer; and
enabling transfer of the subsampled image data to a display processing unit (DPU) of the electronic display for composition of frames having the non-uniform subpixel arrangement.

12. The method of claim 11, further comprising performing pixel binning on the subsampled image data having the subpixel rendered format.

13. The method of claim 12, further comprising performing the pixel binning using rectangle tiles enlarged by N logical pixels, where N is an integer greater than or equal to 1 and is selected to cover overlaps between physical subpixels of the physical pixel layout and logical subpixels of the received image data.

14. The method of claim 11, further comprising performing texture processing on the subsampled image data having the subpixel rendered format.

15. The method of claim 11, further comprising performing antialiasing on the subsampled image data having the subpixel rendered format.

16. The method of claim 11, further comprising rendering only subpixels of the subsampled image data that correspond to physical subpixels disposed on the electronic display.

17. The method of claim 11, further comprising storing in the frame buffer only subpixels of the subsampled image data that correspond to physical subpixels disposed on the electronic display.

18. The method of claim 11, wherein each pixel of the non-uniform subpixel arrangement includes a first subpixel having a first size and a second subpixel having a second size larger than the first size.

19. The method of claim 11, wherein each pixel of the non-uniform subpixel arrangement includes one subpixel having a first color and two subpixels having a second color different from the first color.

20. The method of claim 11, wherein each pixel of the non-uniform subpixel arrangement includes less than three subpixels or more than three subpixels.
